(19) United States
(12) Patent Application Publication
(10) Pub. No.: US 2026/0288539 A1
(43) Pub. Date: Sep. 24, 2026

(54) Platform for Decentralized Management of Generative AI Services in Edge Computing Systems

(71) Applicant: Srikanth Mannem, Lewis Centre, OH (US)

(72) Inventor: Srikanth Mannem, Lewis Centre, OH (US)

(21) Appl. No.: 19/685,165

(22) Filed: May 22, 2026

(51) Int. Cl. G06F 9/50; G06F 9/48; G06N 3/082; G06N 3/098; H04L 9/40; H04L 67/104

(52) U.S. Cl. CPC G06F 9/5077; G06F 9/4881; G06N 3/082; G06N 3/098; H04L 63/0428; H04L 67/1044; G06F 2209/502; G06F 2209/503; G06F 2209/508

(57) ABSTRACT

The present invention discloses a decentralized platform for managing generative artificial intelligence services in edge computing environments. The system comprises a network of distributed edge nodes capable of executing AI models locally, thereby reducing latency, bandwidth usage, and reliance on centralized cloud infrastructure. A decentralized orchestration mechanism dynamically distributes workloads based on real-time parameters such as resource availability, network conditions, and task requirements. The platform incorporates model optimization techniques to enable efficient deployment of generative AI models on resource-constrained devices. Secure communication protocols and trust management systems ensure data integrity, privacy, and node authentication. Additionally, the system supports federated learning for collaborative model improvement without sharing raw data. A monitoring and analytics module provides continuous performance evaluation and adaptive optimization. The invention enables scalable, secure, and efficient deployment of generative AI services across heterogeneous edge environments.

### FIELD OF INVENTION

The present invention generally relates to distributed computing architectures, artificial intelligence service orchestration, and edge computing ecosystems. More specifically, the invention pertains to a decentralized platform and system for orchestrating, deploying, executing, and managing generative artificial intelligence (AI) services—including but not limited to large language models, diffusion models, and multimodal AI systems—across geographically distributed edge nodes. The invention further addresses challenges associated with latency reduction, bandwidth optimization, privacy preservation, computational resource constraints, interoperability, and decentralized governance by introducing an intelligent, adaptive, and secure orchestration framework that operates without reliance on centralized cloud infrastructure.

### BACKGROUND

The accelerated evolution of generative artificial intelligence (AI) technologies has enabled large-scale deployment of AI-driven systems across multiple industrial and commercial domains including healthcare diagnostics, precision manufacturing, financial forecasting, autonomous mobility, cybersecurity, intelligent surveillance, natural language processing, and real-time multimedia content generation. Modern generative AI frameworks frequently employ deep neural network architectures, transformer-based language models, diffusion models, reinforcement learning mechanisms, and multimodal inference engines that require substantial computational resources, memory allocation, and high-throughput data processing capabilities. In conventional implementations, such computational workloads are predominantly executed within centralized cloud computing infrastructures configured to provide elastic scalability, distributed storage, and remote processing services for AI model training and inference operations.

Although centralized cloud environments provide scalable computational infrastructure and high-capacity processing resources, reliance on remote cloud servers introduces significant operational limitations, particularly in latency-sensitive applications requiring deterministic and real-time decision-making. In scenarios including autonomous driving systems, industrial automation platforms, robotic control systems, augmented reality environments, smart healthcare monitoring devices, and mission-critical defense applications, delays associated with transmitting data between edge devices and remote cloud infrastructures can adversely affect responsiveness, reliability, and system safety. Network-induced latency, packet transmission delays, and variable communication bandwidth conditions can degrade inference performance and interrupt continuous execution of time-sensitive AI services.

Furthermore, conventional cloud-centric AI deployment models require continuous transmission of large volumes of sensor data, image streams, telemetry information, and user-generated content from distributed edge devices to centralized processing environments. Such large-scale data transfer operations substantially increase bandwidth utilization and contribute to network congestion, resulting in reduced communication efficiency, elevated operational expenditures, and increased infrastructure overhead. In geographically distributed environments containing numerous Internet-of-Things (IoT) devices, mobile terminals, industrial sensors, and edge gateways, persistent upstream data transmission further creates scalability bottlenecks that impair overall system throughput and limit real-time service availability.

Data privacy, cybersecurity protection, and regulatory compliance requirements have additionally emerged as critical challenges in centralized AI architectures. Sensitive information processed within sectors including healthcare, banking, insurance, legal services, and government infrastructure frequently contains confidential user records, biometric identifiers, financial transactions, or personally identifiable information subject to strict regulatory frameworks and jurisdiction-specific data governance policies. Transmission of such sensitive information to external cloud servers increases exposure to unauthorized access, data interception, cyberattacks, and compliance violations. Regulatory mandates including healthcare privacy standards, financial security regulations, and regional data localization requirements further restrict unrestricted movement of sensitive information across distributed networks and third-party cloud infrastructures.

Edge computing architectures have emerged as a technological approach for addressing limitations associated with centralized cloud-based AI processing by enabling localized computation closer to data generation sources. Edge computing environments distribute computational workloads across edge servers, gateways, embedded systems, mobile devices, and IoT nodes positioned proximate to end-user devices or sensor networks. Localized execution of AI inference operations reduces communication latency, minimizes bandwidth consumption, improves responsiveness, and enhances privacy preservation through reduced dependency on remote cloud infrastructure. However, practical deployment of advanced generative AI models within edge environments remains constrained by resource heterogeneity, limited processing capabilities, constrained memory availability, variable power conditions, and inconsistent communication reliability across distributed edge nodes.

Existing orchestration and workload management mechanisms utilized in distributed computing systems are predominantly centralized in architecture and rely on fixed coordination entities for resource allocation, service deployment, and computational scheduling. Such centralized orchestration frameworks introduce single points of failure, increase vulnerability to network disruptions, and reduce operational resilience within distributed edge ecosystems. Additionally, centralized orchestration approaches exhibit limited adaptability in dynamic edge environments characterized by intermittent connectivity, mobility of edge devices, fluctuating resource availability, and frequent addition or removal of participating nodes. These limitations adversely impact scalability, fault tolerance, and autonomous coordination of AI workloads across decentralized infrastructures.

Conventional workload scheduling and resource management approaches further lack intelligent adaptation mechanisms capable of dynamically optimizing deployment decisions according to real-time network conditions, computational resource availability, device-specific processing capabilities, thermal constraints, energy consumption parameters, and workload priority requirements. Existing systems frequently employ static allocation policies or rule-based scheduling models that do not efficiently respond to changing environmental conditions or workload fluctuations. Consequently, computational resources across distributed edge infrastructures remain underutilized, energy efficiency is reduced, service continuity becomes unreliable, and inference latency increases under variable operational scenarios.

Accordingly, there exists a significant technical need for a decentralized, intelligent, secure, and adaptive orchestration platform configured to manage generative artificial intelligence services across distributed edge computing environments. Such a platform should enable autonomous workload distribution, real-time resource optimization, scalable coordination of heterogeneous edge nodes, fault-tolerant service deployment, privacy-preserving data processing, and adaptive execution of generative AI models while maintaining low latency, high operational efficiency, robust security, and resilient system performance across dynamically changing network environments.

### SUMMARY OF THE INVENTION

The present invention discloses a highly scalable, decentralized, and intelligent platform configured for management, orchestration, optimization, and execution of generative artificial intelligence (AI) services across distributed edge computing environments. The platform enables distributed deployment and autonomous coordination of generative AI workloads without dependency on centralized cloud-based orchestration infrastructures. Through decentralized coordination and adaptive resource allocation, the invention improves system scalability, operational resilience, fault tolerance, latency reduction, and data privacy preservation in heterogeneous edge ecosystems.

In an embodiment, the platform comprises a plurality of heterogeneous edge nodes interconnected through a decentralized peer-to-peer communication network. The edge nodes include edge servers, Internet-of-Things (IoT) gateways, mobile computing devices, embedded controllers, industrial controllers, autonomous systems, smart sensors, vehicular computing units, wearable devices, and distributed micro data centers. The decentralized communication architecture eliminates reliance on centralized supervisory systems and mitigates operational risks associated with centralized single points of failure, network bottlenecks, and service interruptions.

Each edge node is configured to host, execute, manage, and optimize one or more generative artificial intelligence models. The generative AI models include transformer-based large language models, autoregressive neural networks, diffusion-based image synthesis models, generative adversarial networks (GANs), multimodal AI architectures, speech generation models, video generation systems, recommendation engines, and domain-specific inference models. Each node further comprises one or more computational subsystems including central processing units (CPUs), graphics processing units (GPUs), tensor processing units (TPUs), neural processing units (NPUs), field-programmable gate arrays (FPGAs), application-specific integrated circuits (ASICs), or other specialized AI acceleration hardware configured to perform localized inference and model execution operations.

In an embodiment, each edge node further includes local memory resources, non-volatile storage systems, cache memory structures, and distributed data repositories configured to store model parameters, intermediate inference outputs, workload metadata, and operational logs. The local storage architecture enables autonomous execution of AI inference tasks proximate to data generation sources, thereby reducing dependency on remote cloud infrastructures and minimizing communication latency associated with centralized processing systems.

The platform further comprises a decentralized orchestration layer distributed across participating edge nodes and configured to coordinate task allocation, workload scheduling, service provisioning, model deployment, inference execution, resource balancing, and lifecycle management operations. The orchestration layer operates without centralized controllers and instead employs distributed coordination mechanisms enabling cooperative interaction among participating nodes within dynamically changing network topologies. Such distributed orchestration architecture enhances scalability, fault tolerance, and resilience against node failures or communication disruptions.

In certain embodiments, the orchestration layer utilizes distributed consensus mechanisms including Byzantine fault-tolerant protocols, proof-based consensus algorithms, distributed ledger coordination schemes, gossip communication protocols, federated coordination mechanisms, or agent-based cooperative scheduling strategies to ensure synchronized operation among participating edge nodes. The orchestration layer continuously maintains network state awareness and dynamically adapts orchestration policies according to node availability, resource status, and operational conditions within the distributed environment.

The system additionally comprises an intelligent and adaptive scheduling engine configured to analyze and evaluate real-time operational parameters associated with the distributed edge network. Such parameters include node availability, processor utilization, memory utilization, computational throughput, communication latency, network congestion, available bandwidth, workload distribution profiles, energy consumption metrics, battery status, thermal operating conditions, hardware acceleration availability, and application-specific quality-of-service requirements. Based on such evaluations, the scheduling engine dynamically allocates, reallocates, partitions, migrates, or replicates AI workloads across participating edge nodes to achieve optimized performance and balanced utilization of distributed computational resources.

In certain embodiments, the adaptive scheduling engine incorporates machine learning-based predictive optimization techniques configured to forecast workload fluctuations, identify potential bottlenecks, and proactively redistribute computational tasks prior to performance degradation. The scheduling engine may further implement reinforcement learning mechanisms, heuristic optimization algorithms, evolutionary computation methods, or graph-based resource allocation models to continuously optimize workload placement decisions within the decentralized network.

The platform further incorporates a model adaptation and optimization module configured to enable deployment and execution of large-scale generative AI models within resource-constrained edge computing devices. The optimization module applies model compression and acceleration techniques including parameter quantization, neural network pruning, sparse computation optimization, tensor decomposition, knowledge distillation, adaptive layer freezing, operator fusion, low-rank approximation, layer-wise partitioning, and dynamic inference execution strategies. Such optimization mechanisms reduce computational complexity, memory consumption, power utilization, and inference latency while maintaining acceptable levels of model accuracy, output quality, and operational reliability.

In some embodiments, the model adaptation module further supports distributed inference execution through partitioning of neural network layers across multiple cooperating edge nodes. Such distributed inference architecture enables execution of computationally intensive AI models across collaborative node clusters while reducing processing burden on individual devices. The system may additionally support on-device fine-tuning, transfer learning, personalized inference adaptation, and incremental model retraining based on locally generated data.

The platform additionally comprises a secure communication layer configured to facilitate protected data exchange among distributed edge nodes. The communication layer utilizes end-to-end encryption mechanisms, cryptographic key exchange protocols, secure socket communication channels, mutual authentication frameworks, certificate-based validation systems, and secure tunneling protocols to ensure confidentiality, integrity, and authenticity of transmitted information. The communication architecture protects against unauthorized access, data interception, spoofing attacks, tampering attempts, and malicious communication activities within the decentralized environment.

In certain embodiments, the secure communication layer supports both synchronous and asynchronous communication modes to accommodate varying network conditions and application-specific operational requirements. The communication framework further incorporates low-latency transmission optimization techniques, adaptive routing mechanisms, bandwidth-aware communication scheduling, and compressed payload transmission methods to improve communication efficiency within distributed edge infrastructures.

The system further incorporates a distributed trust management framework configured to authenticate participating edge nodes, establish trusted communication relationships, and prevent unauthorized or compromised devices from participating within the network. The trust management framework may implement decentralized identity verification mechanisms, blockchain-based validation infrastructures, cryptographic attestation protocols, hardware-rooted trust anchors, behavioral reputation scoring systems, zero-trust security architectures, or federated authentication techniques to maintain integrity and trustworthiness of network participants.

In an embodiment, the trust management framework continuously monitors node behavior and operational activity to identify anomalous conduct, malicious transactions, unauthorized workload execution, or compromised system behavior. Upon detection of suspicious activity, the framework may isolate affected nodes, revoke communication privileges, redistribute workloads to trusted devices, and initiate automated remediation procedures to preserve operational continuity and network security.

The platform additionally comprises a monitoring and analytics module configured to continuously collect, process, and analyze operational metrics associated with distributed AI service execution. The monitoring module tracks inference latency, throughput rates, processor utilization, memory allocation, network quality indicators, communication delays, energy consumption patterns, workload completion times, model accuracy statistics, error rates, and node availability conditions. Such operational intelligence is provided to the orchestration layer and scheduling engine to facilitate adaptive optimization and autonomous decision-making within the decentralized environment.

In certain embodiments, the monitoring and analytics module further incorporates predictive analytics and anomaly detection capabilities configured to identify abnormal operational conditions, forecast resource exhaustion events, detect communication failures, and anticipate workload congestion scenarios. Predictive insights generated by the analytics module enable proactive scaling, preventive maintenance, automated fault recovery, and dynamic resource provisioning across the distributed edge infrastructure.

The platform further supports dynamic node participation mechanisms enabling edge devices to seamlessly join, exit, reconnect, or migrate within the decentralized network without disrupting ongoing inference operations or service availability. Dynamic node discovery, automatic topology reconfiguration, workload redistribution, and state synchronization mechanisms collectively ensure uninterrupted operation within highly dynamic and mobile edge computing environments.

In some embodiments, the system further incorporates distributed caching mechanisms configured to store frequently accessed inference outputs, model fragments, intermediate computational states, and communication payloads across multiple edge nodes. Such caching architecture reduces redundant computation, decreases communication overhead, and improves inference response times within distributed environments.

The platform may additionally support federated learning frameworks enabling collaborative training and refinement of AI models across distributed edge nodes without centralized aggregation of raw user data. Federated learning operations preserve data privacy by transmitting model parameter updates, gradients, or compressed learning representations instead of sensitive local datasets. Distributed model synchronization and secure aggregation techniques further enhance collaborative intelligence while maintaining regulatory compliance and data confidentiality.

In certain embodiments, distributed model update mechanisms are implemented to propagate optimized model versions, parameter modifications, security patches, and configuration updates across participating nodes in a coordinated and fault-tolerant manner. Incremental synchronization and adaptive update scheduling reduce communication overhead and ensure consistent model execution across geographically distributed infrastructures.

Accordingly, the present invention provides a highly efficient, decentralized, secure, intelligent, and adaptive framework for deployment and orchestration of generative artificial intelligence services within distributed edge computing systems. The disclosed architecture significantly improves inference responsiveness, operational scalability, workload adaptability, resource utilization efficiency, cybersecurity protection, and privacy preservation while overcoming limitations associated with conventional centralized cloud-based AI infrastructures.

### BRIEF DESCRIPTION OF THE DRAWINGS

FIG. 1 illustrates a system-level architecture of the decentralized platform, showing multiple edge nodes interconnected via a peer-to-peer network, along with orchestration, security, and monitoring layers.

FIG. 2 depicts a dynamic workflow of task allocation, where AI inference requests are distributed across edge nodes based on real-time system parameters and decision-making algorithms.

FIG. 3 represents the internal architecture of an edge node, including modules such as AI inference engine, resource manager, communication interface, model optimization unit, and security components.

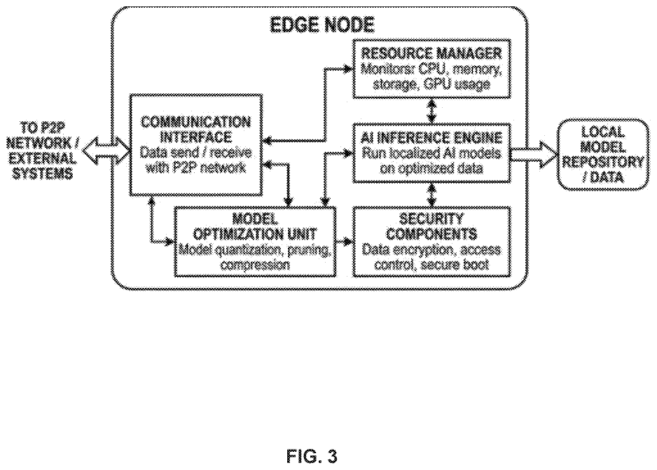

### DETAILED DESCRIPTION

The present invention relates to a decentralized, self-organizing, and intelligence-driven platform for managing, orchestrating, optimizing, and executing generative artificial intelligence (AI) services across distributed edge computing environments. The invention introduces a fundamentally new computing architecture that eliminates dependency on centralized cloud infrastructures and instead enables autonomous collaboration among distributed edge nodes for AI workload execution.

The invention is specifically designed to overcome the inherent limitations of conventional centralized cloud-based AI systems, including but not limited to high network latency, excessive bandwidth consumption, privacy leakage risks, scalability bottlenecks, operational costs, and single point of failure vulnerabilities. By distributing computation closer to the data source and enabling peer-to-peer intelligence coordination, the system achieves significantly improved responsiveness, resilience, and efficiency.

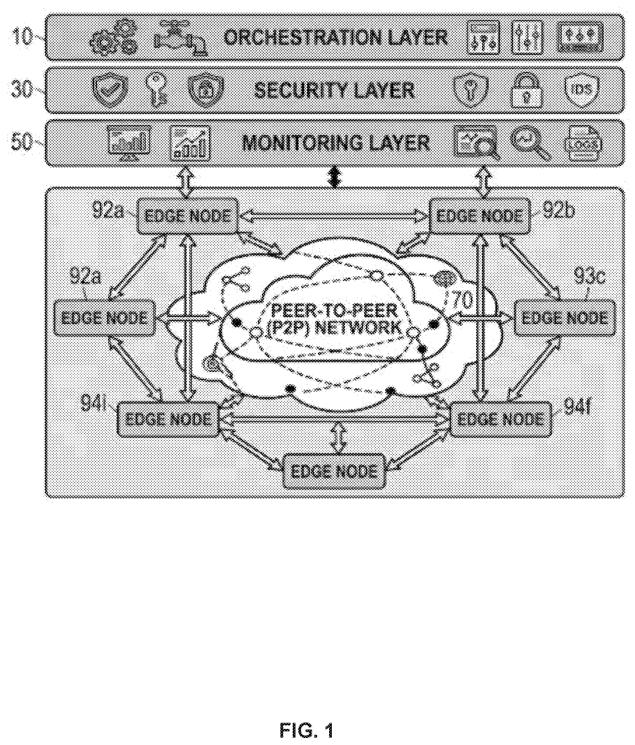

FIG. 1 illustrates a system-level architecture of a decentralized generative artificial intelligence orchestration platform implemented across a distributed edge computing environment. The architecture comprises a plurality of heterogeneous edge nodes 108a-108g interconnected through a decentralized peer-to-peer (P2P) communication network 110 configured to enable autonomous coordination and distributed execution of generative AI services. Each edge node 108a-108g operates as an independent computational entity capable of executing AI inference workloads, participating in distributed decision-making operations, and dynamically sharing computational resources with neighboring nodes. The figure further illustrates an edge intelligence mesh architecture 106 in which computational tasks are executed collaboratively without dependency on centralized cloud orchestration infrastructure.

In an embodiment, FIG. 1 further illustrates a decentralized orchestration layer 100 distributed across multiple edge nodes 108a-108g and configured to manage workload scheduling, AI model deployment, task migration, resource allocation, service replication, and lifecycle management operations. The orchestration layer 100 employs cooperative coordination mechanisms including distributed consensus protocols, federated coordination agents, swarm intelligence frameworks, or decentralized reinforcement learning mechanisms to maintain synchronized operational states across the distributed network.

FIG. 1 additionally illustrates a secure communication layer (represented as security layer 102) configured to facilitate encrypted data exchange and authenticated inter-node communication within the decentralized edge environment. The security layer 102 supports end-to-end encryption, adaptive routing, distributed key management, trust-based authentication, and fault-tolerant message propagation mechanisms. The communication infrastructure enables low-latency synchronization and resilient workload coordination among geographically distributed nodes 108a-108g.

The system architecture illustrated in FIG. 1 further includes a distributed trust management framework within the security layer 102 configured to validate node authenticity, detect malicious activity, and maintain integrity of the decentralized network. In certain embodiments, the trust framework utilizes blockchain-based verification systems, decentralized identity protocols, cryptographic attestation mechanisms, and dynamic reputation scoring models to establish trusted collaboration among participating nodes 108a-108g.

FIG. 1 additionally illustrates a monitoring and analytics layer 104 configured to continuously collect operational metrics associated with node performance, inference execution, resource utilization, communication latency, network congestion, and energy consumption. The monitoring layer 104 provides real-time operational intelligence to the orchestration layer 100 and adaptive scheduling engine to facilitate predictive optimization, anomaly detection, automated scaling, and fault recovery operations.

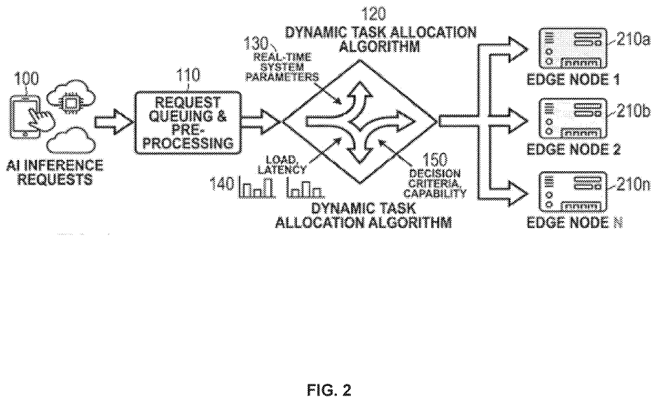

FIG. 2 depicts a dynamic workflow associated with decentralized task allocation and intelligent workload scheduling within the distributed edge computing platform. The workflow begins upon receipt of a generative AI inference request 200 from a client device, sensor network, autonomous system, or distributed application endpoint. The inference request 200 is propagated through the peer-to-peer communication network and evaluated by a request queuing and pre-processing module 202 and the decentralized orchestration layer to determine optimal workload placement.

In an embodiment, FIG. 2 illustrates evaluation of real-time operational parameters (real-time system parameters 206 and load, latency metrics 212) including computational resource availability, processor utilization, memory capacity, thermal operating conditions, communication latency, bandwidth availability, workload priority, node proximity, and energy consumption characteristics. The dynamic task allocation algorithm 204 continuously analyzes such parameters using intelligent decision-making algorithms configured to optimize inference responsiveness and resource utilization efficiency across the distributed edge network.

The workflow illustrated in FIG. 2 further includes dynamic task allocation operations in which AI workloads are assigned to one or more edge nodes 210a, 210b, through 210n determined to possess suitable computational capacity and operational availability based on specific decision criteria and capability metrics 208. In certain embodiments, workload assignment decisions are generated using machine learning-based optimization models, reinforcement learning policies, graph-based scheduling frameworks, heuristic optimization techniques, or consensus-driven coordination protocols.

FIG. 2 additionally illustrates dynamic workload migration and reallocation operations responsive to changing environmental conditions including node failures, resource exhaustion, communication instability, workload spikes, or thermal constraints. Running inference sessions may be transferred between edge nodes 210a-210n through checkpoint synchronization, distributed state serialization, and live migration mechanisms without interruption of ongoing AI services. Such adaptive workload orchestration ensures continuous service availability, balanced resource utilization, and fault-tolerant operation within highly dynamic edge environments.

In certain embodiments, FIG. 2 further illustrates predictive workload optimization operations in which historical operational data and real-time analytics are processed to forecast network congestion events, anticipated workload surges, or node degradation conditions. Based on predictive insights, workloads are proactively redistributed across the edge intelligence nodes 210a-210n to prevent performance bottlenecks and maintain system stability.

The claimed invention is:

1. A decentralized platform for managing generative artificial intelligence (AI) services in edge computing systems, the platform comprising a plurality of distributed edge nodes configured to execute one or more AI models and communicate with each other through a secure peer-to-peer network architecture, wherein the platform operates without reliance on a centralized controller and enables distributed coordination of AI workloads across heterogeneous computing environments.

2. The platform of claim 1, wherein each edge node comprises a local AI inference engine configured to execute generative AI models at the edge, and a resource monitoring module configured to continuously track computational resources including processor utilization, memory consumption, energy usage, and network performance metrics.

3. The platform of claim 1, further comprising a decentralized orchestration module distributed across the plurality of edge nodes, the orchestration module being configured to dynamically coordinate workload distribution, service execution, and task scheduling across the network without a central orchestration entity.

4. The platform of claim 3, wherein workload allocation is dynamically determined based on real-time evaluation of system parameters including available computational capacity, network latency, bandwidth conditions, node proximity, energy constraints, and current workload intensity of each edge node.

5. The platform of claim 1, further comprising a model optimization module configured to transform and adapt large-scale generative AI models for efficient execution on resource-constrained edge devices using one or more techniques selected from model pruning, quantization, knowledge distillation, compression, and distributed model partitioning.

6. The platform of claim 1, further comprising a secure communication layer configured to enable encrypted data exchange between edge nodes, wherein the secure communication layer utilizes cryptographic protocols including end-to-end encryption, secure key exchange mechanisms, and authenticated communication channels.

7. The platform of claim 1, further comprising a distributed trust management system configured to validate participating edge nodes, wherein the trust management system assigns dynamic trust scores based on node behavior, reliability history, computational accuracy, uptime performance, and anomaly detection metrics.

8. The platform of claim 1, wherein the system supports federated learning across the plurality of edge nodes, enabling collaborative training and continuous improvement of generative AI models without requiring centralized aggregation of raw data, thereby preserving data privacy and regulatory compliance.

9. The platform of claim 1, wherein the plurality of edge nodes are configured to dynamically join, leave, or rejoin the network in a plug-and-play manner without disrupting ongoing AI service execution or system-level orchestration processes.

10. The platform of claim 1, wherein the system reduces inference latency, improves computational efficiency, and enhances data privacy by performing localized execution of generative AI workloads directly at the edge nodes instead of transmitting data to centralized cloud infrastructure.
